(19) United States
(12) Patent Application Publication
(10) Pub. No.: US 2014/0292497 A1
(43) Pub. Date: Oct. 2, 2014

(54) Method and Read/Write Device for Detecting, Selecting and Reporting at least one of a Plurality of Contactlessly Readable Transponders

(71) Applicants: Dieter HORST, Cadolzburg (DE); Markus Weinländer, Happurg (DE)

(72) Inventors: Dieter HORST, Cadolzburg (DE); Markus Weinländer, Happurg (DE)

(73) Assignee: Siemens Aktiengesellschaft, Munchen (DE)

(21) Appl. No.: 13/947,895

(22) Filed: Jul. 22, 2013

(30) Foreign Application Priority Data
Jul. 23, 2012 (DE) 10 2012 212 856.5

(51) Int. Cl. G06K 7/00

(52) U.S. Cl. CPC G06K 7/0008
USPC 340/10.51

(57) ABSTRACT

A read/write device and a method for detecting, selecting and reporting a number of transponders from a multiplicity of contactlessly readable transponders to an application, where the read/write device is configured to detect a plurality of transponders within a radio range using at least one read/write cycle, the read/write device is set up with a filter device to select one of the detected transponders, and the read/write device is configured to report the selected transponder to the application. Each transponder belong to functional group, where the read/write device is configured to determine the respective affiliation of detected transponders with one functional group using the data provided by the transponders during their respective detection, and the filter device is configured to select at least one transponder from each of the groups, and the read/write device is configured to report all selected transponders to the application.

### BACKGROUND OF THE INVENTION

1. Field of the Invention

The invention relates to a method and read/write device for detecting, selecting and reporting transponders.

2. Description of the Related Art

Contactlessly readable transponders (“tag”) using radio frequency identification (RFID) technology are often used to contactlessly identify all types of goods and objects. On account of the greater range, ultra-high frequency (UHF) RFID systems are being increasingly used in industrial applications, in particular in automated production systems, instead of high frequency (HF) RFID transponders. The greater range in this case has the disadvantage that a plurality of transponders are often also received at the same time in an undesirable manner, for example, as a result of “overranges”. For such situations, conventional RFID read/write devices are provided with filter devices that are intended to ensure that only a single, particular transponder is reported to an application, such as a control device for an automation task. Such filters regularly use reception parameters, such as, a radio signal strength, to attempt to choose or select that transponder from the set of received or detected transponders which is closest to the application and thus the read/write device.

Possible measures for increasing the reading reliability and for selecting the closest transponder are in the prior art, for example, dynamic adaptation of the transmission power, a threshold value (“threshold”) for the expected minimum signal strength (“RSSI”) of a transponder response or statistical evaluations of a reading frequency in the event of repeated detection. These measures are implemented in the form of filter criteria and filter algorithms in conventional RFID read/write devices to select the “correct” transponder, i.e., the transponder relevant to the respective application, from a broadly detected “transponder population”, in which case it is usually the closest of the transponders, as stated.

However, in particular applications, it is necessary to identify more than one transponder. This may be the case, for example, in a production line where an RFID transponder is respectively fitted both to a workpiece to be machined and to a workpiece carrier (“skid”). In such constellations, it is desirable for both the workpiece and the workpiece carrier to be identified. However, in this case, the situation in which the identification numbers of two workpiece transponders or two workpiece carrier transponders are transmitted to the application of the machining station on account of overranges may unintentionally occur.

However, conventional algorithms are generally only suitable for applications that are intended to be supplied with precisely one identification number of a transponder (“single-tag applications”), or else for a number of the best received transponders.

If these conventional algorithms are intended to be used for applications in which a plurality of transponders must be detected, selected and reported at the same time (“multi-tag applications”), the problem arises of an algorithm often not being able to decide whether the correct transponders have been detected, such as the transponder on the workpiece and that on the workpiece carrier, or whether a transponder detected on account of overranges is contained in the result instead of a desired transponder, for example.

### SUMMARY OF THE INVENTION

It is therefore an object of the present invention to improve the selection when receiving a plurality of RFID transponders in applications which require information relating to a plurality of RFID transponders in a processing step.

This and other objects and advantages are achieved in accordance with the invention in that, from a response message from each transponder, an item of information relating to its function, i.e., an item of semantic information, is obtained in the area surrounding the application. In the abovementioned example, it could therefore emerge, from an item of information stored in the RFID transponders or from coding in an identification number or from an item of type information relating to the transponder, whether the transponder is used to identify a goods item or else to identify a carrier, container, package or “skid”. According to the invention, such information may be used to control filters, but also, additionally or alternatively, to adapt radio parameters of a read/write device by gradually increasing or adapting the transmission field strength of a read/write device, for example, until the desired transponders have been detected and identified in the desired number.

It is also an object to provide a read/write device for detecting, selecting and reporting a number of contactlessly readable transponders to an application is proposed, where the read/write device is set up to detect a multiplicity of transponders within a radio range using at least one read/write cycle, the read/write device with a filter device is set up to select at least one of the detected transponders, and the read/write device is configured to report the selected transponder(s) to the application. In addition, the transponders each belong to one of at least two functional groups, where the read/write device is set up to determine the respective affiliation of the detected transponders with one of the groups using the data provided by the transponders during their respective detection, and the filter device is configured such that it is set up to select at least one transponder from each of the groups, where the read/write device is configured to report all selected transponders to the application. Based on the evaluation of the affiliation with a function, it is possible to determine, for example, what type of function is performed by a detected transponder. Consequently, the filters or radio parameters of the read/write device are controlled such that a result is provided depending on the type of function or type of transponder. Semantic information can therefore be set for the purpose of controlling the read/write device.

It is also an object to provide a method for a read/write device for detecting, selecting and reporting a number of contactlessly readable transponders, where the transponders each belong to one of at least two functional groups and, in order to select and report at least one transponder from each of the groups, the read/write device detects all transponders within a radio range in a first read cycle in a first step, determines the affiliation with a respective group of the functional groups in a second step for each of the detected transponders using the data respectively received during detection, and filters the detected transponders in each group in a third step such that a predefined minimum and/or maximum number of transponders in each group is selected and reported to an application. The method in accordance with the invention makes it possible to achieve the advantages which have already been stated in connection with the read/write device according to the invention.

The filter device can advantageously be set up to use separate filter criteria and/or filter algorithms for the detected transponders in different functional groups. For example, in cases of repeated detection cycles, that transponder with the highest reception field strength Received Signal Strength Indication (RSSI) can be selected for a workpiece transponder and that transponder which is detected the highest number of times can be selected for the workpiece carrier transponder. In the different filter criteria, data relating to the transponders, such as identification numbers or user data, can also be evaluated differently depending on the group or different requirements may be imposed on the quality of the radio link depending on the group.

A minimum and/or maximum number of transponders to be reported to the application can be advantageously defined for each processing branch in the read/write device, i.e., for each different functional group during detection. In particular, it is often possible to stipulate that precisely one transponder is intended to be selected from each group. It is therefore advantageously possible to ensure that a particular number of (usually one) transponders from each involved functional group is reported to a processing station having an application. In this case, a further detection cycle is performed at least for the situation in which the minimum and/or maximum number of transponders to be reported could not be selected for each functional group. In an alternative embodiment, detection cycles may also be performed several times in any case, which provides the advantage that the statistical detection frequency (read rate) of the individual transponders can be used as a parameter for the filters.

When performing a plurality of detection cycles, the read/write device is advantageously set up to dynamically adapt radio parameters, where at least one radio parameter is adapted for the further, next detection cycle after each detection cycle. In this case, the radio parameter(s) is/are intended to be adapted such that a number of detected transponders which is in the target window defined by a minimum and/or maximum number results, as far as possible, for each group. Based on a transmission power, this may mean, for example, that the transmission power is increased for a next detection cycle in the case of too few detected transponders in a group and is otherwise reduced. Additionally or alternatively, other parameters may also be dynamically adapted, for example receiver sensitivity or gain, antenna used, orientation of an antenna, receiver bandwidth etc.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary embodiment of a read/write device according to the invention is explained below using the drawings. The exemplary embodiment is simultaneously used to explain a method according to the invention, in which:

FIG. 1 shows a schematic illustration of an arrangement comprising a read/write device, a computer with an application and a plurality of transponders; and

FIG. 2 shows a schematic illustration of the processing of detected transponders in a read/write device according to the invention; and

FIG. 3 shows a flowchart of the method in accordance with the invention.

### DETAILED DESCRIPTION OF THE PREFERRED EMBODIMENTS

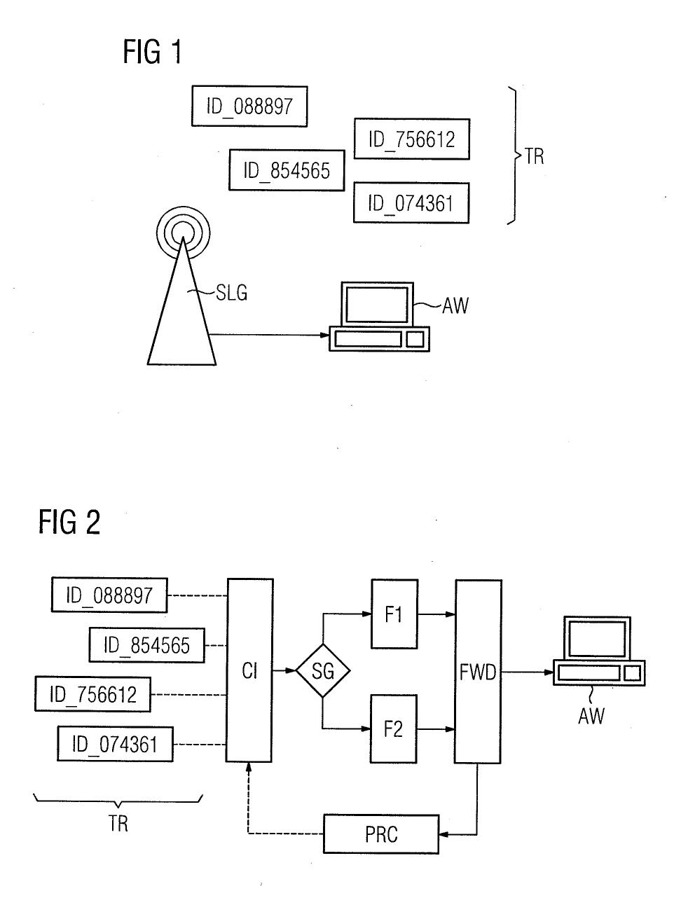

FIG. 1 schematically illustrates a read/write device SLG which is configured to report detected transponders TR to an application AW, where the application AW is able to be a software process of an industrial automation device or of a personal computer. FIG. 1 illustrates, by way of example, four transponders which functionally differ. For the exemplary embodiment, it is assumed that the application AW is associated with a processing station in automobile manufacturing, car bodies being transported, as workpieces, on workpiece carriers, i.e., “skids”, from one processing station to the next. Both the car bodies and the “skids” are each provided with RFID transponders that are intended to be detected by the read/write devices SLG of each processing station. Whereas the transponders of the car bodies and the skids are technically identical, i.e., correspond to the same type, it is specified, in a data bit (flag) in the useful data or the identification or serial number (often called “ID”=“identification”) which can be retrieved from the transponders, whether it is a transponder of a workpiece (car body) or of a workpiece carrier (skid). For the sake of simplicity, it is assumed for the present exemplary embodiment that the functionality is coded in the serial number; this serial number is illustrated in the figures. For example, it is thus possible to state that the transponders with the identification number ID_{—}0XXXXX are used for car bodies and those with the serial numbers ID_YXXXXX, in which the first digit Y is not equal to “0”, are used for skids.

Apart from this example, any distinguishing features of a functional or semantic type may in practice be used to group the transponders TR. It should be noted that it is also possible to use different types of transponders TR for different groups of transponders TR. The important factor here is that a read/write device SLG can use the information received via the air interface to functionally and thus semantically distinguish the transponders TR detected in each case.

FIG. 2 schematically illustrates the data processing inside the read/write device SLG. The transponders TR are detected in a first processing step CI by at least one detection cycle; this processing step is also referred to as “collect inventory”. In this case, at least the serial number ID_YXXXXX of each of the transponders TR is detected. Several parameters (not illustrated here) are additionally likewise detected and stored for each transponder, such as a reception field strength as well as the useful data (user data; “payload”) that are stored in each of the transponders. Depending on the type of application AW, it may be sufficient, on the one hand, to report only the illustrated serial number ID_YXXXXX but, in other cases, the useful data must also be transmitted together with the serial number ID_YXXXXX.

After all of the transponders have been detected in the processing step CI, a distinction is made for each transponder TR regarding which functional group the transponder belongs to in a processing step SG (select group). In the present exemplary embodiment, the coding (already described) in the serial number is used to distinguish whether a “car body transponder” or a “skid transponder” is involved. The data records for the detected serial numbers ID_YXXXXX are accordingly alternatively supplied to the filter stage F1 or to the filter stage F2. In this case, the filter stages F1, F2 substantially correspond to the filters known from the prior art in which, for example, only those transponders which have been received with a sufficient reception field strength or the highest reception field strength or the like are recognized as being valid.

The transponders TR selected by the filter stages F1, F2 are supplied to a further processing stage FWD (forward selected transponder), this processing stage FWD determining whether the desired number of transponders has been detected and selected for each group of transponders TR. This number can be planned or programmed by a user. In the present exemplary embodiment, it is desired, for example, for the filter stages F1, F2 to select precisely one transponder in each case both from the “car body transponders” and from the “skid transponders”. If this is the case, the two selected transponders are reported to the application AW without delay.

If the filter stages F1, F2 were not able to respectively select the desired number of transponders, then the processing stage FWD may, on the one hand, reconfigure the filter stages F1, F2. This means that the filter criteria and/or the filter algorithms can be changed depending on the result actually achieved, after which the same detected stock of transponders is filtered again. For example, if no transponder has been selected at all and this is due to the fact that a required threshold value for the reception field strength has not been reached by any of the transponders, then the threshold value can be reduced, after which the filter stages F1, F2 again filter the transponders TR which have already been detected, after which a satisfactory result is possibly achieved. However, in an alternative embodiment, it is also possible to initiate new detection cycles, in which case a functional unit PRC (power ramp control), for example, adapts the radio parameters for the next detection cycles. In the present exemplary embodiment, the transmission power of the read/write device SLG can be increased, for example, if too few transponders TR have been detected. The transmission power can naturally also be reduced or the sensitivity of the receiver can be reduced, as the opposite measure, if too many undesirable transponders TR have been received.

It is important for the method described and for the read/write device described that data which can be read from the transponders by the read/write device using a radio link are used as filter parameters as a further criterion for the filter stages F1, F2. In this case, a type of application of the transponder TR, for example, is stored as the criterion or parameter, such as in the form of a bit (flag) or a data item in the useful data. Based on this information, the filter stages F1, F2 are then controlled such that the desired number of transponders can be delivered to the application AW, such as a single result depending on the transponder type or application type. It is likewise possible to activate different filters, filter criteria, or filter algorithms depending on the transponder type or application type. In addition to controlling the filter criteria in this manner, it is also possible, according to the disclosed embodiments of the invention, to control the radio parameters, such as transmission power or receiver sensitivity, using the user data or the application or function of the transponders ID. In the case of cyclical detection of transponders ID, a read/write device may thus run through a power curve, where the power or other radio parameters is varied until the desired number of each kind (type) of transponder or the application thereof has been detected. A user can therefore plan how user data, such as the type or application of the transponders ID, are intended to be linked to radio parameters or filter parameters (filter algorithms, filter criteria). The semantics of the application environment are therefore used as an additional criterion for the previously context-free evaluation of a detected transponder population.

In an advantageous embodiment, the read/write device (SLG) can use different radio parameters during a write operation or write cycle depending on the group affiliation of the addressed transponder, for example, can use different transmission powers or different antennas depending on the transponder type or function or can run through a different time/transmission power profile. Here, the same transponder may also belong to different groups for reception and transmission operations.

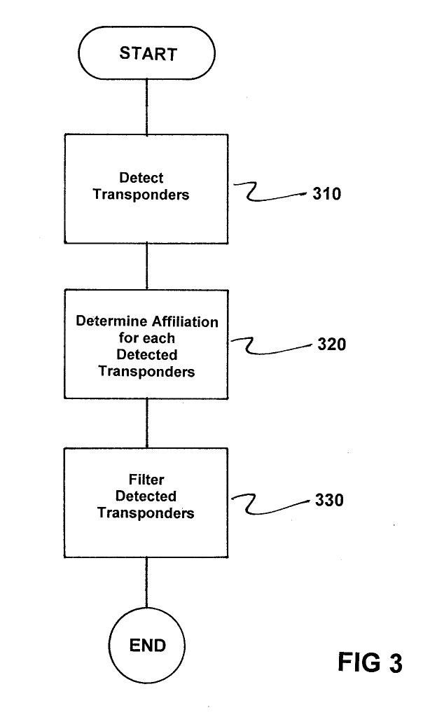

FIG. 3 is a flowchart of a method for a read/write device for detecting, selecting and reporting a number of transponders from a multiplicity of contactlessly readable transponders to an application, each of the contactlessly readable transponders belonging to a functional group of a plurality of functional groups, in order for the read/write device to select and report at least one transponder from each of the functional groups. The method comprises detecting all transponders within a radio range in a first read cycle, as indicated in step 310.

An affiliation with a respective group of the functional groups is then determined for each of the detected transponders using data respectively received during the detection, as indicated in step 320. The detected transponders in each group are now filtered such that at least one of a predefined minimum and a predefined maximum number of transponders in each group is selected and reported to the application, as indicated in step 330.

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A read/write device for detecting, selecting and reporting a number of transponders from a plurality of contactlessly readable transponders to an application,
wherein the read/write device is configured to detect each of the plurality of contactlessly readable transponders within a radio range using at least one read/write cycle;
wherein the the read/write device is set up with a filter device to select at least one detected contactlessly readable transponder of the contactlessly readable transponders;
wherein the read/write device is configured to report selected contactlessly readable transponders of the plurality of contactlessly readable transponders to the application;
wherein each of the plurality of transponders belong to a functional group of a plurality of functional groups;
wherein the read/write device is configured to determine a respective affiliation of the detected contactlessly readable transponder of the contactlessly readable transponders with the functional group of the plurality of functional groups using the data provided by the plurality of contactlessly readable transponders during their respective detection; and
wherein the filter device is configured such that it is set up to select a preconfigured number of contactlessly readable transponders from each functional group of the plurality of functional groups, the read/write device being configured to report all selected transponders of the plurality of transponders to the application.

2. The read/write device as claimed in patent claim 1, wherein the filter device is configured to utilize at least one of (i) separate filter criteria for the detected transponders in different functional groups and (ii) filter algorithms for the detected transponders of the plurality of contactlessly readable transponders in different functional groups.

3. The read/write device as claimed in patent claim 1, wherein at least one of a minimum and a maximum number of transponders of the plurality of contactlessly readable transponders to be reported to the application is defined for each functional group.

4. The read/write device as claimed in patent claim 3, wherein a further detection cycle is performed for the read/write device at least for situations in which at least one of the minimum and the maximum number of transponders of the plurality of contactlessly readable transponders to be reported to the application has not been selected for each functional group.

5. The read/write device as claimed in patent claim 4, wherein the read/write device is configured to dynamically adapt radio parameters, at least one radio parameter being adapted for a further detection cycle after a first detection cycle.

6. The read/write device as claimed in patent claim 5, wherein the read/write device for adapting the at least one radio parameter is configured to change at least one of (i) a transmission power, (ii) a receiver sensitivity and (iii) to change over between a number of alternatively usable antennas.

7. A method for a read/write device for detecting, selecting and reporting a number of transponders from a multiplicity of contactlessly readable transponders to an application, each of the contactlessly readable transponders belonging to a functional group of a plurality of functional groups, in order for the read/write device to select and report at least one transponder from each of the functional groups, the method comprising:
detecting all transponders within a radio range in a first read cycle;
determining an affiliation with a respective group of the functional groups for each of the detected transponders using data respectively received during the detection; and
filtering the detected transponders in each group such that at least one of a predefined minimum and a predefined maximum number of transponders in each group is selected and reported to the application.

8. The method as claimed in patent claim 7, wherein at least one of different filter criteria and different filter algorithms are utilized during said filtering step for each of the functional groups.

9. The method as claimed in patent claim 7, wherein, at least in situations in which a quantity of transponders corresponding to at least one of the predefined minimum and predefined maximum number could not be selected for each group during said filtering step, said detecting, determining and filtering steps being repeated at least once in a further read cycle with changed radio parameters, the radio parameters for at least one further read cycle being adapted until at least one of predefined minimum and predefine maximum number of transponders has been detected, selected and reported to the application for each of the functional groups.

10. The method as claimed in patent claim 8, wherein, at least in situations in which a quantity of transponders corresponding to at least one of the predefined minimum and predefined maximum number could not be selected for each group during said filtering step, said detecting, determining and filtering steps being repeated at least once in a further read cycle with changed radio parameters, the radio parameters for at least one further read cycle being adapted until at least one of predefined minimum and predefine maximum number of transponders has been detected, selected and reported to the application for each of the functional groups.

11. The method as claimed in patent claim 9, wherein, in order to change the radio parameters, the read/write device at least one of (ii) adapts at least one of the transmission power, (ii) adapts the receiver sensitivity and (iii) changes over between a number of alternatively usable antennas.
